(19) United States
(12) Patent Application Publication
(10) Pub. No.: US 2022/0394032 A1
(43) Pub. Date: Dec. 8, 2022

(54) IOT CONNECTION SYSTEM, COMPUTER PROGRAM, AND INFORMATION PROCESSING METHOD

(71) Applicant: IoT-EX Inc., Tokyo (JP)

(72) Inventor: Jun MATSUMURA, Tokyo (JP)

(73) Assignee: IoT-EX Inc., Tokyo (JP)

(21) Appl. No.: 17/775,584

(22) PCT Filed: Oct. 8, 2020
(86) PCT No.: PCT/JP2020/038140

§ 371 Date: May 27, 2022

(30) Foreign Application Priority Data
Nov. 13, 2019 (JP) 2019-205140

(51) Int. Cl. H04L 9/40; H04L 12/28

(52) U.S. Cl. CPC H04L 63/0876; H04L 63/0236; H04L 12/2858

(57) ABSTRACT

An attractive service is provided by freely mutually connecting existing IoT devices in a silo state for each private cloud via the Internet. An IoT connection system includes an IoT hub that is realized over a cloud and a local IoT router that is connected to the IoT hub. The IoT hub includes at least one of a first driver configured to connect the IoT hub to a private cloud to which a first device is able to be connected and a second driver configured to connect a second device to the IoT hub. The IoT router includes a third driver configured to connect a third device to the IoT router. The IoT router is an information processing terminal that is able to communicate with a predetermined base station. The third device is connected to the IoT hub using a tethering function of the IoT router in a specific situation.

### TECHNICAL FIELD

The present disclosure relates to an IoT connection system, a computer program, and an information processing method.

### BACKGROUND ART

Recently, the number of devices that can access the Internet and receive various services has increased. Such devices are called Internet of Things (IoT) devices.

In general, since such IoT devices are individually connected to dedicated private clouds, IoT devices with different specifications which are manufactured by different makers cannot be connected to the same private cloud.

Recently, an IoT cloud service which is called an IoT hub that can allow IoT devices manufactured by various makers to be connected thereto by publishing an application programming interface (API) for connection to a cloud or providing a software development kit (SDK) or the like has also been provided (such as Non Patent Literature 1 and Non Patent Literature 2).

### CITATION LIST

### Non Patent Literature

### Non Patent Literature 1

“Azure IoT Hub,” Microsoft, [retrieved Jun. 2, 2019], Internet <https://azure.microsoft.com/ja-jp/serviceshot-hub/>

### Non Patent Literature 2

“AWS IoT,” Amazon Web Services, [retrieved Jun. 2, 2019], Internet <https://aws.amazon.com/jp/iot/>

### SUMMARY OF INVENTION

### Technical Problem

Although the aforementioned IoT cloud services exist, cooperation between the services is limited and companies of IoT devices need to develop dedicated connection programs which differ depending on the services and incorporate the connection programs into the devices.

Therefore, an objective of the present disclosure is to provide an attractive service by freely mutually connecting existing IoT devices in a silo state for each private cloud via the Internet.

### Solution to Problem

An IoT connection system according to the present disclosure is an IoT connection system including an IoT hub that is realized over a cloud and a local IoT router that is connected to the IoT hub, wherein the IoT hub includes at least one of a first driver configured to connect the IoT hub to a private cloud to which a first device is able to be connected and a second driver configured to connect a second device to the IoT hub, the IoT router includes a third driver configured to connect a third device to the IoT router, the IoT router is an information processing terminal that is able to communicate with a predetermined base station, and the third device is connected to the IoT hub using a tethering function of the IoT router in a specific situation.

The specific situation may be a situation in which the third device is disconnected from a predetermined wireless/wired LAN.

The IoT router may be remotely controlled by a manager device.

At least one of the first driver, the second driver, and the third driver may realize a virtual device function of virtually reproducing the first device, the second device, or the third device.

The IoT hub may realize a directory function of causing the first device, the second device, the third device, and an IoT service available via the IoT hub to cooperate with each other.

The directory function may identify the first device, the second drive, or the third device or the IoT service and give an instruction to the first device, the second device, or the third device or the IoT service.

The IoT hub may further include a Web API for use of an IoT application.

Information which is acquired from the first device, the second device, or the third device is not stored in the IoT hub.

A computer program according to the present disclosure is a computer program that is executed in an IoT connection system including an IoT hub that is realized over a cloud and a local IoT router that is connected to the IoT hub, wherein the IoT hub includes at least one of a first driver configured to connect the IoT hub to a private cloud to which a first device is able to be connected and a second driver configured to connect a second device to the IoT hub, the IoT router includes a third driver configured to connect a third device to the IoT router, and the IoT router that is a mobile device that is able to communicate with a predetermined base station is caused to perform: a determination function of determining whether the IoT router is in a specific situation;

and a tethering function of causing the third device to continuously transmit and receive information to and from the IoT hub via the mobile-phone communication network when it is determined through the determination function that the IoT router is in the specific situation.

An information processing method according to the present disclosure is an information processing method that is performed in an IoT connection system including an IoT hub that is realized over a cloud and a local IoT router that is connected to the IoT hub, wherein the IoT hub includes at least one of a first driver configured to connect the IoT hub to a private cloud to which a first device is able to be connected and a second driver configured to connect a second device to the IoT hub, the IoT router includes a third driver configured to connect a third device to the IoT router, and the IoT router that is a mobile device that is able to communicate with a predetermined base station is caused to perform: a determination step of determining whether the IoT router is in a specific situation; and a tethering step of causing the third device to continuously transmit and receive information to and from the IoT hub via the mobile-phone communication network when it is determined in the determination step that the IoT router is in the specific situation.

### Advantageous Effects of Invention

According to the present disclosure, it is possible to provide an attractive service by freely mutually connecting existing IoT devices in a silo state for each private cloud via the Internet.

Specifically, according to the present disclosure, it is possible to easily mutually connect IoT devices connected to existing private clouds as well as those directly connected IoT devices.

According to the present disclosure, it is possible to provide an IoT connection system, a computer program, and an information processing method that can continue to provide services even in a state such as power failure in which IoT devices cannot be connected to a network.

### BRIEF DESCRIPTION OF DRAWINGS

FIG. 1 is a system configuration diagram illustrating an example of a configuration of an IoT connection system according to an embodiment of the present disclosure.

FIG. 2 is a diagram illustrating an example of a plurality of private clouds in the IoT connection system according to the embodiment of the present disclosure.

FIG. 3 is a diagram illustrating an example of a plurality of first devices which are connected to private clouds in the IoT connection system according to the embodiment of the present disclosure.

FIG. 4 is a diagram illustrating an example of a flow of a service which is provided by the IoT connection system according to the embodiment of the present disclosure.

FIG. 5 is a hardware configuration diagram illustrating a hardware configuration of an IoT router according to the embodiment of the present disclosure.

FIG. 6 is a diagram illustrating an example of a flow of a service which is provided by the IoT connection system according to the embodiment of the present disclosure.

FIG. 7 is a diagram illustrating another example of a flow of a service which is provided by the IoT connection system according to the embodiment of the present disclosure.

FIG. 8 is a diagram illustrating an example of a flow of a virtual driver function which is provided by the IoT connection system according to the embodiment of the present disclosure.

FIG. 9 is a diagram illustrating another example of a flow of a virtual driver function which is provided by the IoT connection system according to the embodiment of the present disclosure.

FIG. 10 is a configuration diagram illustrating a configuration and a circuit configuration of the IoT router according to the embodiment of the present disclosure.

FIG. 11 is a flowchart illustrating an example of a flow of an information processing method according to an embodiment of the present disclosure.

### DESCRIPTION OF EMBODIMENTS

Hereinafter, an IoT connection system according to an embodiment of the present disclosure will be described with reference to the accompanying drawings.

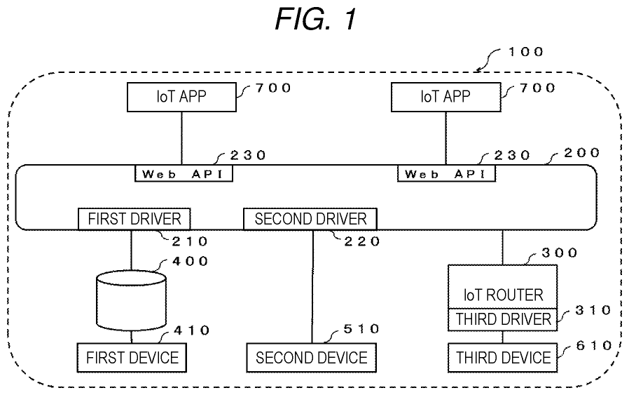

As illustrated in FIG. 1, an IoT connection system 100 according to the present disclosure includes an IoT hub 200 and an IoT router 300.

The IoT hub 200 is realized over a cloud. Specifically, the IoT hub 200 is a managed service hosted in a cloud and serves as a relay for bidirectional communication between an IoT application (hereinafter referred to as an “IoT app”) and an IoT device.

The IoT router 300 is local and is connected to the IoT hub 200 by a wide area network (WAN).

Specifically, the IoT router 300 serves to realize connection of an IoT device that is not connected to the Internet, such as an in-house network, to the IoT hub 200.

The IoT hub 200 includes a first driver 210 and a second driver 220.

The first driver 210 and the second driver 220 serve to absorb a difference in specifications between makers of IoT devices.

The first driver 210 serves to connect a private cloud 400 to which a first device 410 is able to be connected to the IoT hub 200.

For example, it is preferable that the first device 410 and the private cloud 400 be connected by a local area network (LAN) and the private cloud 400 and the first driver 210 be connected by a WAN.

The private cloud 400 is provided by a provider of the first device 410. The number of private clouds 400 in FIG. 1 is one, but it is not limited thereto and a plurality of private clouds 400 may be connected to the IoT hub 200. The IoT hub 200 may include a plurality of first drivers 210.

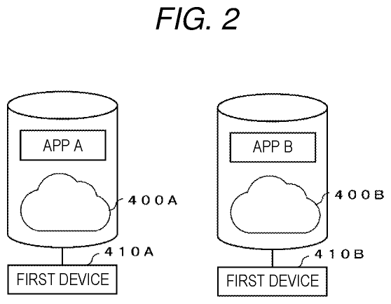

FIG. 2 illustrates details of two private clouds 400A and 400B which are provided by different providers A and B. As illustrated in FIG. 2, the private cloud 400A is connected to an application A (hereinafter referred to as “app A”) which is provided by a provider A and provides a service based on the app A to a first device 410.

Similarly, the private cloud 400B is connected to an application B (hereinafter referred to as “app B”) which is provided by a provider B and provides a service based on the app B to a first device 410.

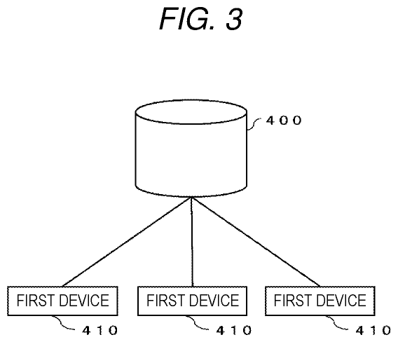

FIGS. 1 and 2 illustrate examples in which only one first device 410 is connected to one private cloud 400, but a plurality of first devices 410 may be connected to one private cloud 400 as illustrated in FIG. 3.

The first device 410 may be a device for which a private cloud is provided by a provider. Examples thereof include an electronic lock having a remote lock function, an AI speaker, and a nursing bed which is able to be remotely operated, but the first device is not particularly limited thereto.

The second driver 220 serves to directly connect a second device 510 to the IoT hub 200.

For example, it is preferable that the second device 510 and the second driver 220 be connected by a LAN.

FIG. 1 illustrates an example in which only one second device 510 is connected to the second driver 220, but a plurality of second devices 510 may be connected to one second driver 220. The IoT hub 200 may include a plurality of second drivers 220.

The second device 510 may be a device for which a private cloud is not provided by a provider. Examples thereof include a fan, an air conditioner, a window, a curtain, and a light, but the second device is not particularly limited thereto.

The IoT router 300 includes a third driver 310. The IoT router 300 may include a plurality of third drivers 310.

The third driver 310 serves to connect a third device 610 to the IoT router 300.

For example, it is preferable that the third device 610 and the third driver 310 be connected by a LAN and the IoT router 300 and the IoT hub 200 be connected by a WAN.

As described above, the third device 610 may be an IoT device which is not connected to the Internet such as an in-house network. The third device 610 may be a device which should not be directly connected to the IoT hub 200 from a point of view of security, privacy, and safety. Examples thereof include a gas stove, a face authentication device, and a sensor information collection data logger, but the third device is not particularly limited thereto. From a point of view of reducing a risk in disasters which will be described later, any device may be connected as the third device 610 to the IoT router 300.

In this way, the IoT connection system 100 according to the invention is a hybrid type IoT connection system that connects some devices to a local IoT router 300 instead of directly connecting all devices to the IoT hub 200 in a cloud.

With this configuration, it is possible to easily mutually connect IoT devices connected to an existing private cloud as well as IoT devices which are directly connected.

Accordingly, unlike the related art in which only IoT devices of a predetermined maker are connected, it is possible to easily mutually connect IoT devices of various makers. By mutually connecting IoT devices of various makers, it is possible to provide a unique service which was not provided in the related art.

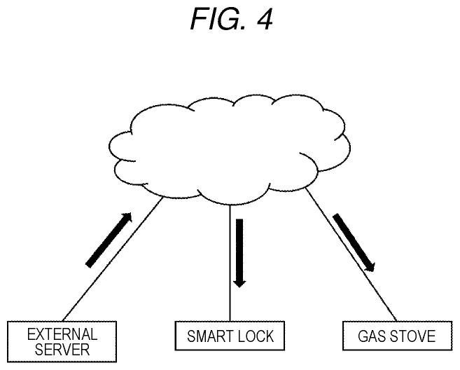

For example, with the IoT connection system 100 according to the invention, when emergency earthquake news is received from an external server as illustrated in FIG. 4, it is possible to easily realize a service of transmitting a flameout signal to a gas stove and unlocking a front door.

It is preferable that the IoT router 300 be an information processing terminal which can communicate with a predetermined base station.

For example, the information processing terminal which can communicate with a predetermined base station is an information processing terminal into which a SIM card is inserted for use such as a smartphone or a tablet terminal. Since a communication capacity between the IoT router 300 and the IoT hub 200 is a low capacity which is equal to or less than 100 Mbyte per month, a low-price SIM card with a low communication capacity can be satisfactorily inserted into the IoT router 300.

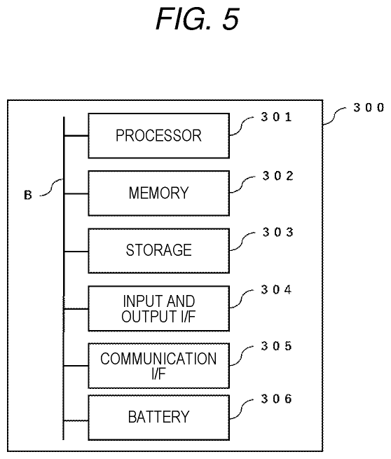

A hardware configuration of the information processing terminal 300 (the IoT router 300) will be described below with reference to FIG. 5. The information processing terminal 300 includes a processor 301, a memory 302, a storage 303, an input and output interface (an input and output I/F) 304, and a communication interface (a communication I/F) 305. These constituents are connected to each other via a bus B.

The information processing terminal 300 can realize functions and methods described in the embodiment by cooperation between the processor 301, the memory 302, the storage 303, the input and output I/F 304, and the communication I/F 305.

The processor 301 performs functions and/or methods which are realized by codes or commands included in a program stored in the storage 303. The processor 301 may include, for example, a central processing unit (CPU), a micro processing unit (MPU), a graphics processing unit (GPU), a microprocessor, a processor core, a multiprocessor, an application-specific integrated circuit (ASIC), or a field-programmable gate array (FPGA) and realize processes disclosed in the embodiments using a logical circuit (hardware) or a dedicated circuit formed of an integrated circuit (IC) or a large scale integration (LSI) circuit. These circuits may be realized by one or more integrated circuits, or a plurality of processes described in the embodiments may be realized by one integrated circuit. LSI may be called as VLSI, super LSI, ultra LSI, or the like depending on a difference in a degree of integration.

The memory 302 temporarily stores a program loaded from the storage 303 and provides a work area to the processor 301. The memory 302 temporarily stores various types of data which are generated while the processor 301 is executing the program. The memory 302 includes, for example, a random access memory (RAM) and a read only memory (ROM).

The storage 303 stores a program. The storage 303 includes, for example, a hard disk drive (HDD), a solid state drive (SSD), and a flash memory.

The communication I/F 305 is mounted as hardware such as a network adaptor, communication software, or a combination thereof and transmits and receives various data via a network 1600. This communication may be performed in one of a wired manner and a wireless manner and may employ any communication protocol as long as mutual communication can be performed. The communication I/F 305 performs communication with another information processing device via a network. The communication I/F 305 transmits various types of data to another information processing device in response to an instruction from the processor 301. The communication I/F 305 receives various types of data transmitted from another information processing device and transmits the received data to the processor 301.

The input and output I/F 304 includes an input device that receives various operations on the information processing terminal 300 and an output device that outputs processing results processed by the information processing terminal 300. In the input and output I/F 304, the input device and the output device may be unified, or the input device and the output device may be separated from each other.

The input device is realized by one of all types of devices which can receive an input from a user and transmit information associated with the input to the processor 301 or a combination thereof. The input device includes, for example, a touch panel, a touch display, or hardware keys such as a keyboard, a pointing device such as a mouse, a camera (an operation input by an image), and a microphone (an operation input by voice).

The output device outputs a processing result processed by the processor 301. The output device includes, for example, a touch panel and a speaker.

It is assumed that the information processing terminal 300 includes a battery. Such a battery can store electric power by charging. The information processing terminal 300 can realize the functions in the present disclosure without being connected to a power source in about 3 days from a fully charged state. In a normal state (situations other than a specific situation which will be described later), it is assumed that the information processing terminal 300 be connected to a power source for use.

It is assumed that the third device 610 be connected to the IoT hub 200 using a tethering function of the IoT router 300 in a specific situation.

The specific situation may be a situation in which the third device 610 is disconnected from a predetermined wireless/wired LAN, or the like, but is not limited thereto.

One reason for falling in to such a specific situation is blackout, but is not limited thereto and the reason may be malfunction, connection failure, or the like of a Wi-Fi (registered trademark) router.

A known technique can be used as the tethering function and for example, technique such as Wi-Fi tethering, Bluetooth (registered trademark) tethering, or USB tethering can be used.

With this configuration, it is possible to provide an attractive service by freely mutually connecting existing IoT devices in a silo state for each private cloud via the Internet.

Specifically, according to the present disclosure, it is possible to easily mutually connect IoT devices connected to an existing private cloud as well as IoT devices which are directly connected.

With this configuration, by connecting the third device 610 to the IoT hub 200 using the tethering function of the IoT router 300 in a specific situation, it is possible to continuously use a service even in a state in which IoT devices cannot be connected to a network in disasters or the like.

It is preferable that the IoT router 300 can be remotely controlled by a manager device. With this configuration, it is possible to fully support each of the IoT routers.

The remote control is realized by installing a dedicated application in both the manager device and the IoT router 300. In consideration of easiness of supporting the remote control, it is preferable that an Android terminal be used as the information processing terminal serving as the IoT router 300.

It is preferable that the IoT router 300 be subjected to various device management (VDM) by the manager device. Such VDM can be realized using an existing mobile device management (MDM) technique. With this configuration, it is possible to immediately unitarily manage, remotely monitor, and update IoT routers which are installed in a large number of households. Setting of a device and distribution and update of an application can be remotely monitored and controlled through VDM. Accordingly, it is possible to realize reduction of cost and an increase in business efficiency.

Only an authenticated application or device can be connected to the IoT hub 200, but the IoT router 300 can extend the IoT hub 200 locally (to a house or the like) such that it is possible to achieve a real-time properties, securement of security or privacy, reduction of an amount of communication data, and the like which can be only locally realized.

By employing an information processing terminal as the IoT router 300, it is not necessary to use a client's smartphone or an Internet circuit line in a house and it is possible to reduce a risk in which troubles other than supposed occur.

In the IoT connection system 100 according to the present disclosure, information which a user should describe to create the first driver 210, the second driver 220, and the third driver 310 may be limited to information on device definitions and command definitions.

A method of creating the first driver 210, the second driver 220, and the third driver 310 will be described below. A creator may be a user associated with manufacturing and development of IoT devices or a user associated with provision of the IoT connection system according to the present disclosure.

Regarding the first driver 210, the second driver 220, and the third driver 310, information of the same details can be described, and it may be described in different programming languages.

First, a creator defines an available device list as device definitions. For example, when a “weather sensor,” an “indoor sensor,” an “outdoor sensor,” a “suspicious person sensor,” an “approval sensor,” and a “power sensor” are defined as available devices, names thereof and “weather,” “inhouse,” “outdoor,” “security,” “approve,” and “power” which are IDs thereof are described.

Subsequently, the creator defines available commands as command definitions. For example, when available commands for the “outdoor sensor” are defined, an observation command for a sensor value is described. Examples of the observation command include “observe,” “get,” and “observe outdoors.”

By causing a creator to embed such information on device definitions and command definitions in a program in a hole filling manner, the first driver 210, the second driver 220, and the third driver 310 can be completed. The other parts can be provided as an SDK from a provider.

The SDK part includes a part associated with a device operation process in the received command, a part associated with a pre-process of the collected sensor data/operation result data, and a part associated with a process of transmitting data to the IoT hub.

With this configuration, since drivers for various types of IoT devices can be simply completed, it is possible to realize an IoT connection system that can flexibly and easily connect IoT devices.

In general, the technical field of engineers associated with device development is different from that of engineers for Web development and many engineers for device development do not have the technical expertise to connect devices to an IoT hub.

Accordingly, as in the present disclosure, it is very profitable for any driver program to be able to be created using a simple method in a hole filling manner. Accordingly, it is possible to reduce development costs or development periods associated with connection of an IoT device to an IoT hub in comparison with those in the related art.

Even when there is a difference in allowable costs like a fan and an air conditioner, it is possible to equally realize connection thereof to an IoT hub through a decrease in development costs.

Connection between an IoT hub 200 and an IoT app associated with the IoT connection system 100 according to the present disclosure will be described below.

As illustrated in FIG. 1, an IoT hub 200 may include a Web API 230 for use of an IoT application 700. As illustrated in FIG. 1, IoT applications 700 corresponding to the number of services can be connected and each can be connected using a Web API 230.

Each IoT application 700 is created by describing a data acquisition logic from an IoT device (sensor) and/or an operation logic of the IoT devices in an application.

The data acquisition logic includes a part for pre-processing the acquired sensor data and a part for performing transmission to an API of the IoT hub 200. Necessary information includes a destination URL which is provided by a provider of the IoT connection system 100, an API key which is provided by a provider, device information, and an execution command

The device operation logic includes a part for pre-processing a command for a device to be operated and a part for performing transmission to an API of the IoT hub 200. Necessary information includes a destination URL which is provided by the provider of the IoT connection system 100, an API key which is provided by the provider, device information, and an execution command

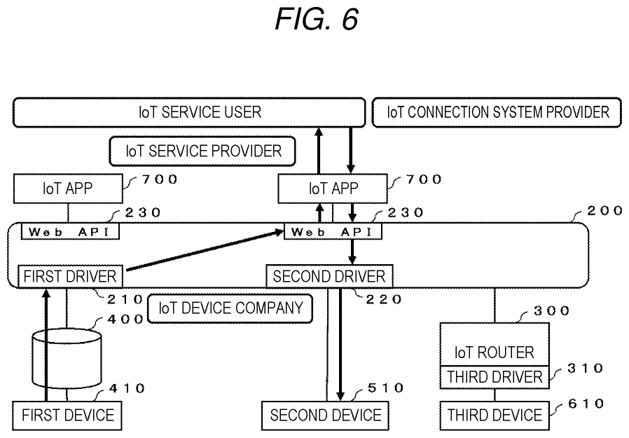

FIG. 6 is a diagram illustrating a flow in which an IoT service user (an end user) is provided with an IoT service from an IoT service provider using an IoT device which is provided by the IoT device provider. As illustrated in FIG. 6, when an event is first transmitted from a first device 410, the end user is notified of the event via the private cloud 400, the first driver 210, the Web API 230, and the IoT application 700.

Subsequently, when the end user determines an action, the second device 510 is instructed to execute the action via the IoT application 700, the Web API 230, and the second driver 220.

Cooperation between IoT devices can be expressed by an event-driving program such as “OO, if˜.” This process can be made into a component as a micro service, can be commonalized for use, and can be mounted as a function of a service (FaaS) function.

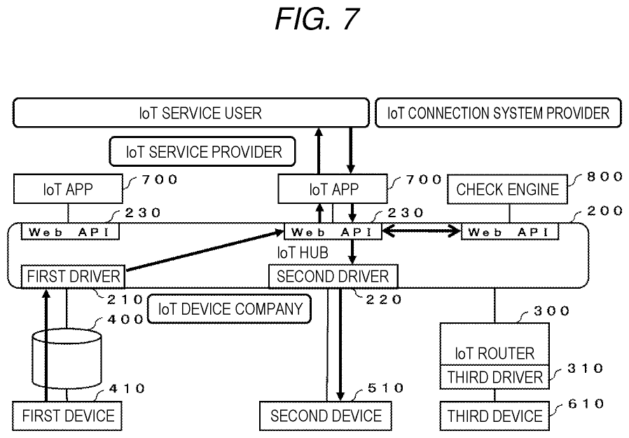

As illustrated in FIG. 7, the IoT hub 200 according to the present disclosure can be connected to a check engine 800. The check engine 800 serves to check details of which a device is instructed by the IoT hub 200 and to prevent an inappropriate action from being executed.

For example, when an IoT service, “an air conditioner is stopped and a window is opened if outside air is fair,” is provided, the inside may get wet if an unexpected rainstorm strikes immediately after, and the check engine 800 serves to prevent such a threat derived from an IoT service.

At least one of the first driver 210, the second driver 220, and the third driver 310 according to the present disclosure can realize a virtual device function.

The virtual device function is for virtually reproducing the first device 410, the second device 510, or the third device 610.

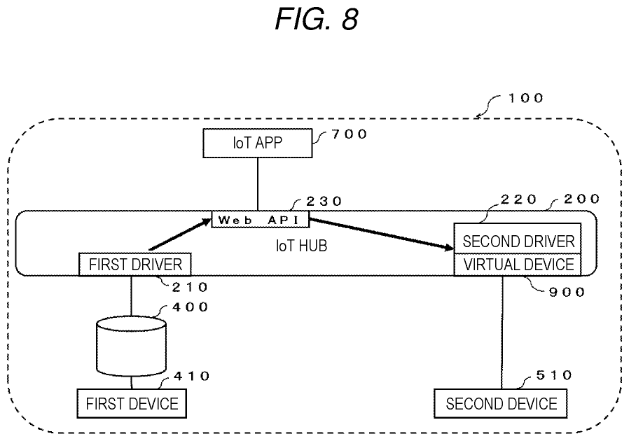

FIG. 8 illustrates an example in which the second driver 220 according to the present disclosure realizes the virtual device function. As illustrated in FIG. 8, by providing a virtual device 900 that can reproduce transmission and reception of a command for the second device 510 in the second driver 220, it is possible to develop an IoT application using the second device 510 even when the second device 510 is not connected. When an operation failure occurs, it is possible to easily perform failure identification of determining which of the second device 510 and the IoT hub 200 is out of order without visiting the spot.

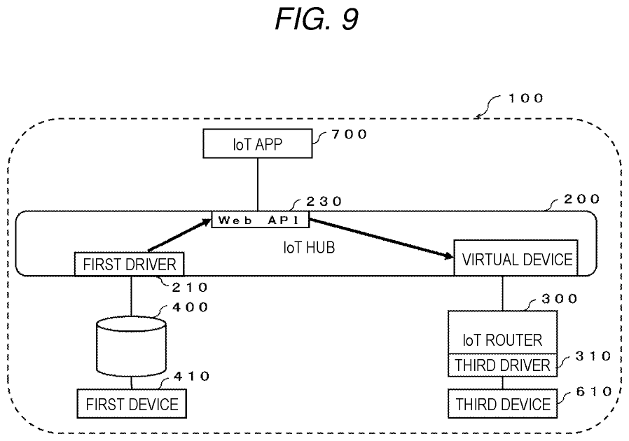

According to the present disclosure, the IoT hub 200 may realize the virtual device function instead of a driver as illustrated in FIG. 9. This is effective for failure identification of the third device 610 connected to the local IoT router 300. The IoT hub 200 in the IoT connection system 100 according to the invention can realize a directory function.

The directory function is for causing the first device 410, the second device 510, and the third device 610 to cooperate with an IoT service which can be used via the IoT hub 200.

That is, the directory function is for realizing a function of identifying objects or services such that a path from an object (device) to a service, from a service to an object, and from an object to an object can be ascertained and providing instructions to the objects or the services.

Specifically, the directory function can identify the first device 410, the second device 510, or the third device 610 or the IoT service or provide instructions to the first device 410, the second device 510, or the third device 610 or the IoT service.

In the IoT connection system 100 according to the invention, information acquired from the first device 410, the second device 510, or the third device 610 may not be stored in the IoT hub 200.

It is supposed that the IoT connection system 100 according to the invention is run by a telecommunications carrier. A telecommunication carrier has an obligation to keep communication secrets, and thus does not store information acquired from various devices for other purposes of utilization.

Since such information is valuable information, an IoT device is generally enclosed in a private cloud of each carrier in order to exclusively acquire such information.

On the other hand, with the IoT connection system 100 according to the invention, since it is run by a telecommunications carrier, it is possible to mutually connect IoT devices and IoT applications at a neutral position and to promote IoT business.

Since continuity of an IoT mutual connection service affects continuity of an IoT service of a corporation using the IoT mutual connection service, it is preferable that the corporations share a mutual connection infrastructure.

In the IoT connection system 100 according to the invention, only devices or IoT applications which are permitted using an API key and an authentication scheme can be connected to the IoT hub 200. That is, the IoT connection system 100 according to the invention can construct a closed network dedicated for IoT communication over the Internet. Since communication paths are encrypted and IoT routers are managed by a mobile device management (MDM) technique, it is also possible to cope with new attacks or weaknesses of an OS or applications.

When it is intended to connect non-IoT devices to the IoT hub 200, it is possible to perform development in a short time by utilizing backend as a service (BaaS) or SDK.

The provider of the IoT connection system 100 can propose a mutual connection support service of an IoT device. Specifically, it is possible to provide business matching and consulting services. That is, in order to provide added value, it is possible to search for necessary opponents and to perform introduction of value creation patterns and best practices thereto or the like.

It is possible to create an attractive service by combination with devices or applications of other providers and to expand business by bringing added value.

A computer program according to an embodiment of the present disclosure will be described below.

The computer program according to the present disclosure is executed in an IoT connection system 100 including an IoT hub 200 that is realized over a cloud and a local IoT router 300 that is connected to the IoT hub as illustrated in FIG. 1.

The IoT hub 200 includes at least one of a first driver 210 configured to connect the IoT hub 200 to a private cloud 400 to which a first device 410 is able to be connected and a second driver 220 configured to connect a second device 510 to the IoT hub 200, and the IoT router 300 includes a third driver 310 configured to connect a third device 610 to the IoT router 300.

The computer program according to the present disclosure causes the IoT router 300 which is an information processing terminal communicating with a predetermined base station to perform a determination function and a connection function.

The determination function is for determining whether the third device 610 is in a specific situation.

The connection function is for connecting the third device 610 to the IoT hub 200 using a tethering function when it is determined through the determination function that the third device 610 is in a specific situation.

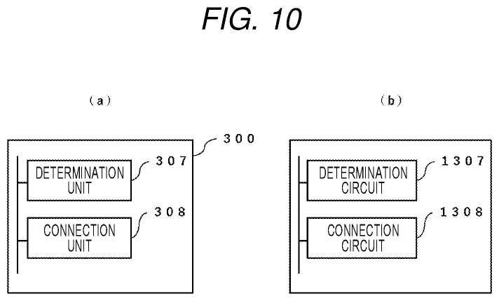

The functions can be realized by a determination circuit 1307 and a connection circuit 1308 illustrated in FIG. 10(b). The determination circuit 1307 and the connection circuit 1308 are realized by a determination unit 307 and a connection unit 308 of the IoT router 300 illustrated in FIG. 10(a).

With this configuration, it is possible to provide an attractive service by freely mutually connecting existing IoT devices in a silo state for each private cloud via the Internet.

Specifically, according to the present disclosure, it is possible to easily mutually connect IoT devices connected to an existing private cloud as well as IoT devices which are directly connected.

With this configuration, by connecting the third device 610 to the IoT hub 200 using the tethering function of the IoT router 300 in a specific situation, it is possible to continuously use a service even in a state in which IoT devices cannot be connected to a network in disasters or the like.

An information processing method according to the present disclosure will be finally described below.

As illustrated in FIG. 1, the information processing method according to the present disclosure is performed in an IoT connection system 100 including an IoT hub 200 that is realized over a cloud and a local IoT router 300 that is connected to the IoT hub.

The IoT hub includes at least one of a first driver configured to connect the IoT hub to a private cloud to which a first device is able to be connected and a second driver configured to connect a second device to the IoT hub.

The IoT hub 200 includes at least one of a first driver 210 configured to connect the IoT hub 200 to the private cloud 400 to which the first device 410 is able to be connected and a second driver 220 configured to connect the second device 510 to the IoT hub 200, and the IoT router 300 includes a third driver 310 configured to connect the third device 610 to the IoT router 300.

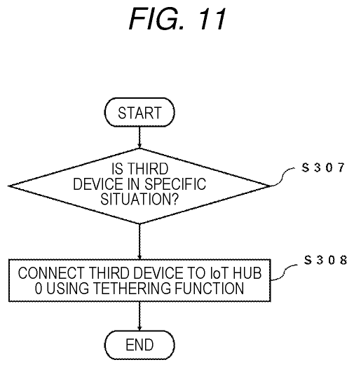

The information processing method according to the present disclosure causes the IoT router 300 which is an information processing terminal communicating with a predetermined base station to perform a determination step and a connection step as illustrated in FIG. 11.

The determination step S308 is for determining whether the third device 610 is in a specific situation. The determination step S308 can be realized by the determination unit 307 of the IoT router 300 as illustrated in FIG. 10(a).

The connection step S309 is for connecting the third device 610 to the IoT hub 200 using a tethering function when it is determined in the determination step S308 that the third device 610 is in a specific situation. The connection step 309 can be realized by the connection unit 308 of the IoT router 300 as illustrated in FIG. 10(a).

With this configuration, it is possible to provide an attractive service by freely mutually connecting existing IoT devices in a silo state for each private cloud via the Internet.

Specifically, according to the present disclosure, it is possible to easily mutually connect IoT devices connected to an existing private cloud as well as IoT devices which are directly connected.

With this configuration, by connecting the third device 610 to the IoT hub 200 using the tethering function of the IoT router 300 in a specific situation, it is possible to continuously use a service even in a state in which IoT devices cannot be connected to a network in disasters or the like.

While some embodiments of the invention have been described above, the embodiments are merely presented as examples and are not intended to limit the scope of the invention. The embodiments can be embodied in various other forms and can be subjected to various omissions, substitutions, and alterations without departing from the gist of the invention. Novel embodiments or modifications thereof belong to the scope or gist of the invention and also belong to the inventions described in the appended claims and a scope equivalent thereto.

The techniques described above in the embodiments may be stored as a program which can be executed by a calculator (computer) in a recording medium such as a magnetic disk (such as a Floppy (registered trademark) disk or a hard disk), an optical disc (such as a CD-ROM, a DVD, or a MO), or a semiconductor memory (such as a ROM, a RAM, or a flash memory), or may be transmitted and distributed through a communication medium. The program stored in the medium side includes a setting program in which a software means (including a table or a data structure in addition to an execution program) which is performed by a calculator is installed in the calculator. The calculator that realizes the device according to the invention performs the aforementioned processes by reading a program recorded on a recording medium, constructing a software means using a setting program in some case, and controlling operations using the software means. The recording medium mentioned in this specification is not limited to a medium for distribution, and includes a storage medium such as a magnetic disk or a semiconductor memory that is provided in a calculator or a device connected thereto via a network. The storage unit may also serve as, for example, a main storage device, an auxiliary storage device, or a cache storage device.

### REFERENCE SIGNS LIST

100 IoT connection system

200 IoT hub

210 First driver

220 Second driver

230 Web API

300 IoT router

310 Third driver

400 Private cloud

410 First device

510 Second device

610 Third device

700 IoT app

800 Check engine

900 Virtual device

1. An internet of things (IoT) connection system comprising:
an IoT hub that is realized over a cloud; and
a local IoT router that is connected to the IoT hub, wherein the IoT hub includes at least one of a first driver configured to connect the IoT hub to a private cloud to which a first device is able to be connected and a second driver configured to connect a second device to the IoT hub,
the IoT router includes a third driver configured to connect a third device to the IoT router,
the IoT router is a mobile device that is able to be connected to a mobile-phone communication network even in a specific situation, and
the third device continues to transmit and receive information to and from the IoT hub even in the specific situation using a tethering function of the IoT router.

2. The IoT connection system according to claim 1, wherein the third device is a device of which connection to the Internet is prohibited in view of securing safety or protecting private information and the IoT router which is a device authenticated by the IoT hub relays information to the third device.

3. The IoT connection system according to claim 1, wherein a plurality of IoT routers are connected to the IoT hub, and
wherein device setting and application distribution and update of the plurality of IoT routers are remotely unitarily controlled by a manager device.

4. The IoT connection system according to claim 1 wherein at least one of the first driver, the second driver, and the third driver realizes a virtual device function of virtually reproducing the first device, the second device, or the third device.

5. The IoT connection system according to claim 1, wherein the IoT hub realizes a directory function of causing the first device, the second device, the third device, and an IoT service available via the IoT hub to cooperate with each other.

6. The IoT connection system according to claim 5, wherein the directory function identifies the first device, the second drive, the third device, or the IoT service and gives an instruction to the first device, the second device, the third device, or the IoT service.

7. The IoT connection system according to claim 1, wherein the IoT hub further includes a Web API for use of an IoT application.

8. The IoT connection system according to claim 1 wherein information which is acquired from the first device, the second device, or the third device is not stored in the IoT hub.

9. A computer program that is executed in an internet of things (IoT) connection system including an IoT hub that is realized over a cloud and a local IoT router that is connected to the IoT hub,
wherein the IoT hub includes at least one of a first driver configured to connect the IoT hub to a private cloud to which a first device is able to be connected and a second driver configured to connect a second device to the IoT hub,
wherein the IoT router includes a third driver configured to connect a third device to the IoT router, and
wherein the IoT router that is a mobile device that is able to be connected to a mobile-phone communication network is caused to perform:
a determination function of determining whether the IoT router is in a specific situation; and
a tethering function of causing the third device to continuously transmit and receive information to and from the IoT hub via the mobile-phone communication network when it is determined through the determination function that the IoT router is in the specific situation.

10. An information processing method that is performed in an internet of things (IoT) connection system including an IoT hub that is realized over a cloud and a local IoT router that is connected to the IoT hub,
wherein the IoT hub includes at least one of a first driver configured to connect the IoT hub to a private cloud to which a first device is able to be connected and a second driver configured to connect a second device to the IoT hub,
wherein the IoT router includes a third driver configured to connect a third device to the IoT router, and
wherein the IoT router that is a mobile device that is able to be connected to a mobile-phone communication network is caused to perform:
a determination step of determining whether the IoT router is in a specific situation; and
a tethering step of causing the third device to continuously transmit and receive information to and from the IoT hub via the mobile-phone communication network when it is determined in the determination step that the IoT router is in the specific situation.
